(19) United States
(12) Patent Application Publication
(10) Pub. No.: US 2002/0184322 A1
(43) Pub. Date: Dec. 5, 2002

(54) System and method for sending imaging data via email

(76) Inventors: Shell S. Simpson, Boise, ID (US); Ward S. Foster, Boise, ID (US); Kris R. Livingston, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/874,480

(22) Filed: Jun. 4, 2001

(51) Int. Cl. G06F 15/16

(52) U.S. Cl. 709/206; 709/204

(57) ABSTRACT

A system and method for sending, via email, imaging data stored in a personal imaging repository located on a computer connected to an email web server providing an email web service. The present invention includes a personal imaging repository for storing imaging data that is to be accessed by requested web services, an email web content for emailing selected imaging data stored in the personal imaging repository responsive to user selection, such that the email web content is generated by the email web server and available for transferring to a browser. An email web server for providing the email web content and transferring the selected imaging data to a recipient mail server is further included. The personal imaging repository is an exchange infrastructure between the imaging data and available web services on the Internet.

The present invention generally relates to an improved system and method for sending imaging data via email. More specifically, it relates to an improved system and method for sending, via email, imaging data stored in a personal imaging repository linked to an imaging client computer having a browser operably connected to an email web server that provides an email web service.

It is becoming more common for users to send imaging data, such as a picture file or a Portable Document Format (“PDF”) file via email. Currently, in order for the user to send an email, it is generally first required that an email program be installed on the user's computer. Although there are several web-based email applications available on the Internet, most email programs require users to indicate the location of the requested files before they can be attached to the email message. The same is true even when the user is using a web-based email application. However, this is problematic because it is common for users to forget where they last stored the requested file. Even if users recall where they last stored the requested file, they may not necessarily have access to their requested file because most likely it is stored on the hard drive of their personal computer at home.

### BRIEF SUMMARY OF THE INVENTION

The present invention is directed to an improved system and method for sending imaging data stored in a personal imaging repository via email. More particularly, a system and method for sending, via email, imaging data stored in a personal imaging repository linked to an imaging client computer having a browser operably connected to an email web server that provides an email web service. It should also be noted that although the use of “a” computer or server will sometimes be referred to for better readability, it should be understood that the use of “a” also refers to “one or more”.

The present invention comprises a system that includes a personal imaging repository for storing imaging data that is to be accessed by requested web services, an email web content for emailing selected imaging data stored in the personal imaging repository responsive to user selection, such that the email web content is generated by the email web server and available for transferring to a browser. An email web server for providing the email web content and transferring the selected imaging data to a recipient mail server is further included. The personal imaging repository is an exchange infrastructure between the imaging data and available web services on the Internet.

The present invention further comprises a method for sending, via email, imaging data stored on a personal imaging repository, storing imaging data in an imaging data store and storing imaging compositions having links to the imaging data serviced as a single unit in a composition store, located on a computer connected to an email web server that provides an email web service. The method includes the steps of requesting web content from the email web service by the imaging client computer, responding to the request by supplying email web content to the imaging client computer by the email web server, displaying and executing the email web content by the imaging client computer, accessing selected imaging data from the personal imaging repository by the email web content, transferring selected imaging data along with user configuration to the email server by the email web content, and sending the imaging data and the user configuration with an email message to the recipient mail server.

### DESCRIPTION OF THE DRAWINGS

FIG. 1 is a preferred architectural diagram of a network system in which the present invention can be implemented;

FIG. 2 is an architectural diagram of a second network system in which the present invention can be implemented;

FIG. 3 is a flowchart illustrating the preferred functionality of the email method of the present invention;

FIG. 4 illustrates an exemplary page of the email web content; and,

FIG. 5 illustrates another exemplary page of the email web content.

### GLOSSARY OF TERMS AND ACRONYMS

The following terms and acronyms are used throughout the detailed description:

Client-Server. A model of interaction in a distributed system in which a program at one site sends a request to a program at another site and waits for a response. The requesting program is called the “client,” and the program which responds to the request is called the “server.” In the context of the World Wide Web (discussed below), the client is a “Web browser” (or simply “browser”) which runs on the computer of a user; the program which responds to browser requests by serving Web pages, or other types of Web content, is commonly referred to as a “Web server.”

Composition store. Composition store refers to a network service or a storage device for storing imaging composition(s) that can be accessed by the user or other web services.

Content. A set of executable instructions that is served by a server to a client and that is intended to be executed by the client so as to provide the client with certain functionality. Web content refers to content that is meant to be executed by operation of a Web browser. Web content, therefore, may non-exhaustively include one or more of the following: HTML code, SGML code, XML code, XSL code, CSS code, Java applet, JavaScript and C-“Sharp” code.

Exchange infrastructure. An exchange infrastructure is a collection of services distributed throughout a network that stores imaging data associated with a particular user through a user profile.

Hyperlink. A navigational link from one document to another, from one portion (or component) of a document to another, or to a Web resource, such as a Java applet. Typically, a hyperlink is displayed as a highlighted word or phrase that can be selected by clicking on it using a mouse to jump to the associated document or document portion or to retrieve a particular resource.

Hypertext System. A computer-based informational system in which documents (and possibly other types of data entities) are linked together via hyperlinks to form a user-navigable “web.”

Imaging composition. An imaging composition comprises links to imaging data serviced as a single unit.

Imaging data. Imaging data refers to digital data capable of being represented as two dimensional graphics, such as a Portable Document Format (“PDF”) file or a Joint Photographic Experts Group (“JPEG”) file.

Imaging data store. Imaging data store refers to a network service or a storage device for storing imaging data that can be accessed by the user or other network services. The imaging data store preferably accepts the imaging data in multiple standard file formats, and the imaging data is converted into these file formats when necessary depending on the implementation.

Internet. A collection of interconnected or disconnected networks (public and/or private) that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols.)

World Wide Web (“Web”). Used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

Web Site. A computer system that serves informational content over a network using the standard protocols of the World Wide Web. Typically, a Web site corresponds to a particular Internet domain name, such as “HP.com,” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users. Importantly, a Web Site can have additional functionality, for example, a Web site may have the ability to print documents, scan documents, etc.

HTML (HyperText Markup Language). A standard coding convention and set of codes for attaching presentation and linking attributes to informational content within documents. (HTML 2.0 is currently the primary standard used for generating Web documents.) During a document authoring stage, the HTML codes (referred to as “tags”) are embedded within the informational content of the document. When the Web document (or HTML document) is subsequently transferred from a Web server to a browser, the codes are interpreted by the browser and used to display the document. Additionally in specifying how the Web browser is to display the document, HTML tags can be used to create links to other Web documents (commonly referred to as “hyperlinks”). For more information on HTML, see Ian S. Graham, The HTML Source Book, John Wiley and Sons, Inc., 1995 (ISBN 0471-11894-4).

HTTP (HyperText Transport Protocol). The standard World Wide Web client-server protocol used for the exchange of information (such as HTML documents, and client requests for such documents) between a browser and a Web server. HTTP includes a number of different types of messages which can be sent from the client to the server to request different types of server actions. For example, a “GET” message, which has the format GET <URL>, causes the server to return the document or file located at the specified URL.

URL (Uniform Resource Locator). A unique address which fully specifies the location of a file or other resource on the Internet or a network. The general format of a URL is protocol: //machine address:port/path/filename.

User Information. User information is identification and security information used in accessing imaging composition(s) and imaging data associated with a particular user profile. It is preferably accessed either directly or indirectly through methods provided by an extension component integrated into the web browser.

PDA (Personal Digital Assistant). A small hand-held computer used to write notes, track appointments, email and web browser with generally with far less storage capacity than a desktop computer.

Personal imaging repository. A personal imaging repository is a conceptual term describing the exchange infrastructure used to exchange imaging composition and imaging data with web services. Users are associated with their imaging data through user profiles.

### DETAILED DESCRIPTION

Broadly stated, the present invention is directed to an improved system and method for sending imaging data stored in a personal imaging repository via email. The system and method provide for the sending of imaging data stored in a personal imaging repository that is associated with a user via email. In addition, the personal imaging repository acts as an exchange infrastructure for any available web services on the Internet. As a result, users can utilize the imaging data stored in the personal imaging repository more readily and easily.

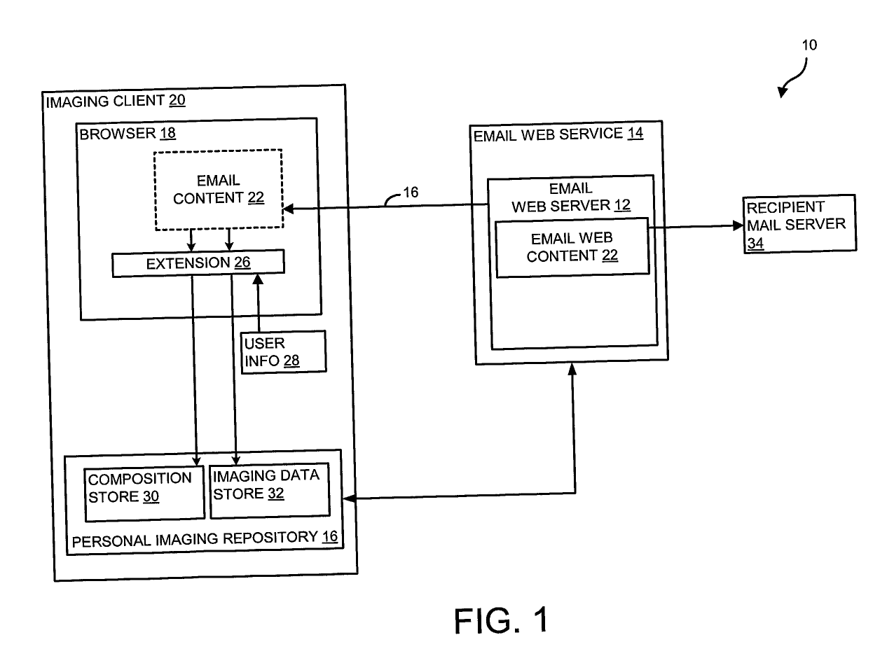

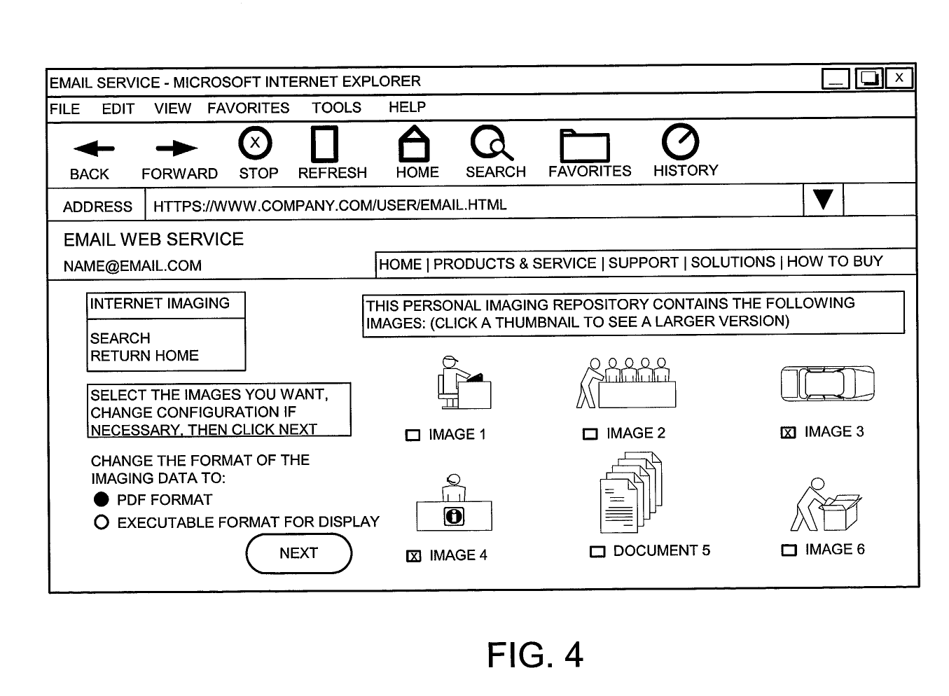

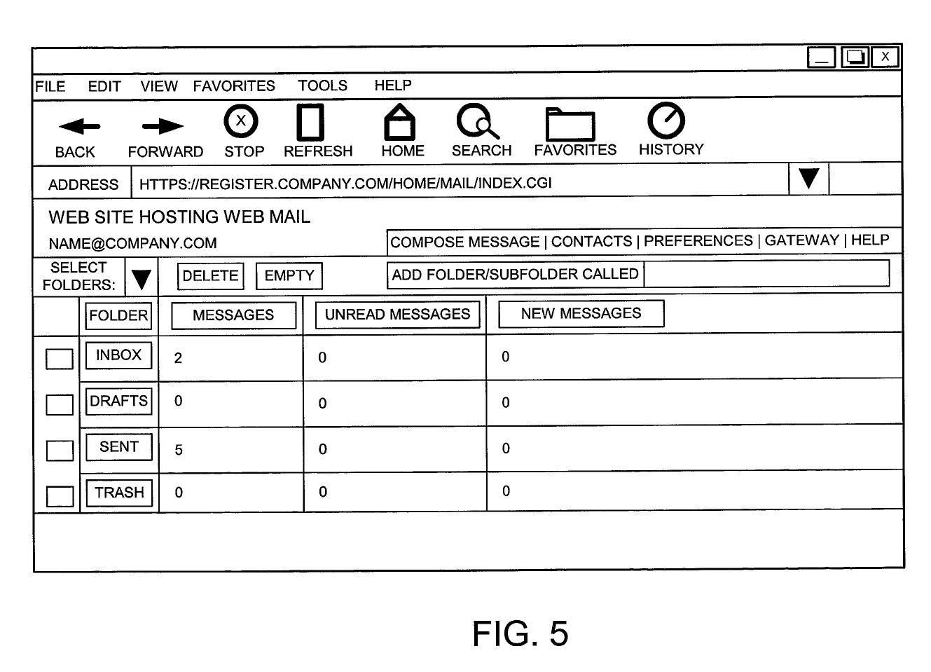

The preferred network system in which the present invention can be implemented is shown in FIG. 1 and indicated generally at 10. The email web server computer 12 provides an email web service 14, which allows users to select and email imaging data that are stored on a personal imaging repository 16. The email web server computer 12 is accessed through a browser 18 located on an imaging client computer 20. When the browser 18 browses to the email web service 14, the email web server 12 responds with an email web content 22 that allows the user to select and email imaging data stored on the personal imaging repository 16 (exemplary pages of the email web content are shown in FIGS. 4 and 5). The email web content 22 is executed by the browser 18. The browser 18 also includes an extension component 26, which makes use of user information 28 that associates or links the email web content 22 with the personal imaging repository 16 that belongs to that particular user.

In the present invention, it is preferred that the personal imaging repository 16 include a composition store 30 for storing imaging compositions of the imaging data that are serviced as a single unit and an imaging data store 32 for storing the imaging data. An imaging composition includes links to the imaging data, which can be located on another web service. As a result, the composition store 30 stores only the imaging compositions. The imaging data store 32, on the other hand, is any imaging data store located on any computer that offers access to the imaging data. More specifically, each web service can have its own imaging data store 32 available to the public.

For example, at some earlier time, a user may print an article from a web service site, resulting in an imaging composition being created and stored in the user's composition store. The imaging composition contains only the link to the imaging data for this article stored on the web service site. Consequently, the imaging data for the article is not located in the imaging data store that resides on the imaging client 20. Rather, the imaging data is stored on the imaging data store on the web service site. Of course, users will have an imaging data store that belongs to their user identification where they can store imaging data, which is the imaging data store shown in the imaging client. As a result, the term “personal imaging repository” 16 is meant as a conceptual term for an exchange infrastructure between the imaging data and the available web services on the Internet. Similarly, the term “web” denotes millions of distinct servers that provide the web. However, the web does not actually do anything itself. Similarly, the servers serving the composition store and the imaging data store are physical implementations of the personal imaging repository as a concept.

In the implementation shown in FIG. 1, when a user requests selected imaging data to be emailed to a recipient, the email web content will access the imaging data stored on the personal imaging repository 16 indicated by the user information 28 accessed by the extension component 26. Because the personal imaging repository 16 acts as an exchange infrastructure between the imaging data and the available services on the Internet, the user need not indicate to the email web service 14 where the imaging data is stored.

The users no longer have to remember in which directory they placed the selected imaging data. When the user requests web services for any of the imaging data stored in the personal imaging repository, the requested web service is configured to access imaging data stored in the personal imaging repository. Furthermore, since the email web service is web-based, it is unnecessary for the user to download and install software for emailing these imaging data stored in the personal imaging repository 16.

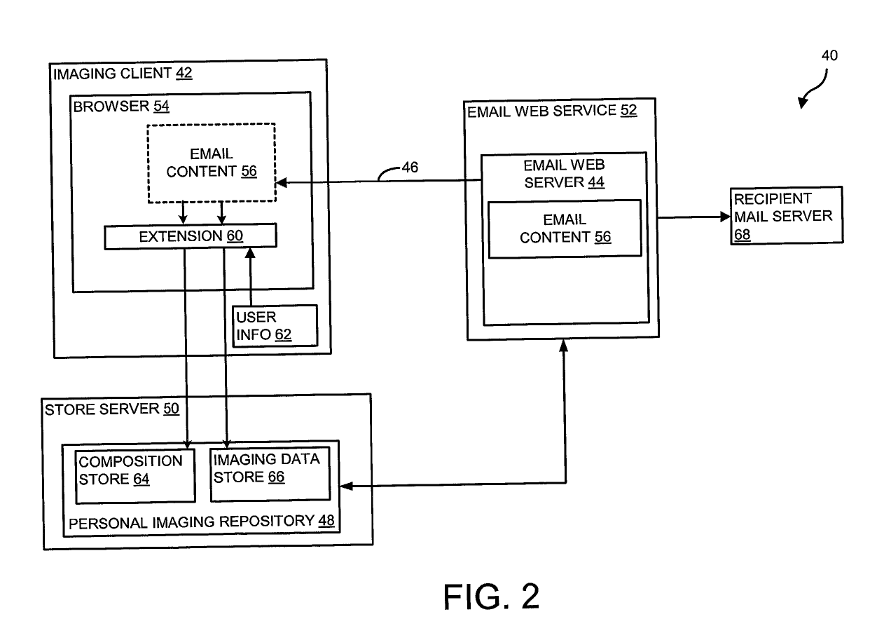

It should be noted that the personal imaging repository 16 can represent any type of data storage device. In fact, the personal imaging repository 16 does not necessarily have to be located within the imaging client computer 20. The personal imaging repository 16 can be located, for example, on another computer, which the client machine can access through alternative communication links. Furthermore, although both the composition store 30 and the imaging data store 32 of the personal imaging repository 16 are shown on a single computer, it is possible for the imaging data store to be on the imaging client while the composition store can be accessed from another computer over the Internet. Although it is currently preferred that the personal imaging repository 22 be included in the imaging client, this would likely change as the bandwidth becomes faster and the popularity of personal digital assistants (“PDA”) increases. These alternative implementations are contemplated, and should be considered within the scope of the present invention. One preferred embodiment that is more tailored to faster bandwidth or any client machine with limited storage capacity is shown in FIG. 2.

A second network system is shown in FIG. 2, and indicated generally at 40. In this implementation, multiple users can utilize the same imaging client computer 42 that is connected to an email web server 44 through the Internet 46. In this implementation, the imaging client computer 42 can include client computers that have less storage memory, such as a Personal Digital Assistant (“PDA”) or a laptop. Because of the limit on the storage memory, the personal imaging repository 48 for storing a user's imaging data is located on a store server 50 that, although linked to the imaging client computer 42, is separated physically from the imaging client computer, which can also be a server computer or a linked client machine.

Similarly, the email web server provides an email web service 52 for emailing selected imaging data stored in the personal imaging repository 48. Using a browser 54 located on the imaging client computer 42, the user browses to the web service 52, which responds by displaying an email web content 56. The browser 54 executes this email web content 56 on the browser. The browser further includes an extension component 60 that makes use of user information 62 to associate the email web content 56 with the personal imaging repository 48 assigned to this user. The personal imaging repository 48, in this second embodiment, similarly includes a composition store 64 for storing imaging compositions and an imaging data store 66 for storing imaging data. Once the user has selected the imaging data and finished configuring the email message, the email web content sends the email message to the recipient mail server 68.

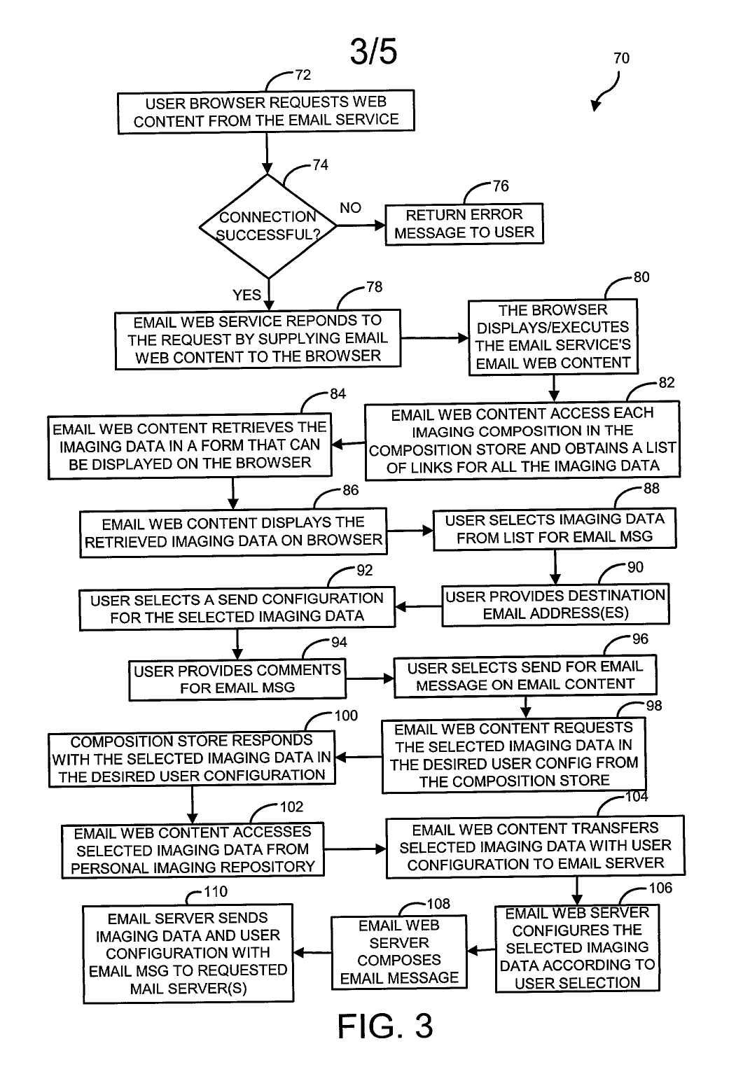

Turning to an important aspect of the present invention, a flow chart of the preferred functionality of the email method is shown in FIG. 3, and indicated generally at 70. The imaging client computer, or more specifically the browser of the client computer, requests web content from the email service (block 72). It is determined whether the imaging client computer has established a successful connection with the email web service (block 74). If no connection has been established (block 74), the imaging client computer returns an error message to the user (block 76), which then ends the process. Otherwise, once a connection to a web service is established (block 74), the email service responds to the request by supplying email web content to the browser (block 78). The browser accordingly displays and executes the email web content from the email service (block 80), which accesses each imaging composition stored in the composition store and obtains a list of links for all the imaging data (block 82). The email web content retrieves the imaging data in a form that can be displayed on the browser (block 84), and displays these retrieved imaging data on the browser (block 86) (an exemplary page of the browser produced by the web application content is shown in FIG. 4).

It should be noted that the list of all the imaging data includes the imaging data that can be retrieved from the imaging data stores located on the linked web services and the imaging client. The imaging data are linked by references in the imaging compositions that are stored in the composition store belonging to the user. A list of imaging data is compiled from the links referenced in all the imaging compositions. The user then selects the imaging data to be included for this email message (block 88) and the destination email address(es) (block 90). However, it should also be noted that user selection from the list is an optional step. Alternate implementations can be used. For example, the email web content can be configured to select preselected imaging data. These other implementations are within the scope of the present invention. Additionally, the user can also include any send configuration for the imaging data if necessary (block 92) and comments to email messages (block 94).

It should also be noted that there are numerous ways to design the email web content, and each email web content can include a variety of send configurations for the imaging data, such as sending the imaging data in PDF format or executable format (i.e., a format that includes the program code to display the imaging data). Once the user is satisfied with the email message and selects SEND on one of the pages displayed by the email web content (not shown) (block 96), the email web content responds by requesting the selected imaging data in the desired user configuration from the composition store of the personal imaging repository (block 98). The composition store accordingly responds with the selected imaging data in the desired user configuration to the email web content (block 100).

More specifically, the email web content accesses the selected imaging data in the desired configuration from the personal imaging repository (block 102). The email web content then transfers the selected imaging data with the desired user configuration to the email server (block 104), which configures the selected imaging data according to user selection (block 106). For example, the imaging data store may give us the imaging data in a PDF format, but the user may have requested that the imaging data be sent as an executable format. In that case, the email server includes additional functionality of converting the PDF file into an executable format. However, at times, the email server configures the selected imaging data by doing nothing with the file format that the imaging data store provided, since the user asked for a file format that does not require additional modification. As previously explained, how the email server configures the selected imaging data depends solely upon what the user selections were. After the imaging file is ready, the email server composes the email message (block 108), and sends the imaging data and the email message to the recipient server (block 110).

Exemplary pages of the email web content are shown in FIGS. 4 and 5. The email web content in FIG. 4 shows a total of six (6) imaging data (e.g., 5 images and 1 document) that are available on the personal imaging repository. In this example, image 3 and image 4 are selected and ready to be transferred. Optional image features may be included, such as requesting the imaging data be a PDF format or an executable format that can display the imaging data. Once the user has selected the desired images, the user can then press the NEXT button on the email web content to go to another page, which may include additional user configurations. Another example of pages included with the email web content can be a typical web mail default page for users to manage their emails, as shown in FIG. 5. Because there are many pages and user options that could be included with the email web content, FIGS. 4 and 5 are shown only as examples of the kinds of pages that can be included. These various implementations of the email web content are contemplated and are within the scope of the present invention.

From the foregoing description, it should be understood that an improved system and method for sending imaging data stored a personal imaging repository via email has been shown and described, which has many desirable attributes and advantages. The system and method provide for the emailing of imaging data stored in a personal imaging repository that is designed to be an exchange infrastructure between the imaging data and web services that are available on the Internet. The users no longer need to recall where their previous transferred files are located on their hard disk. The present invention allows the user to email selected imaging data from a personal imaging repository in a quick and convenient manner for the user. In addition, the users can easily manage their imaging data with fewer limitations.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A system for sending, via email, imaging data stored in a personal imaging repository linked to an imaging client computer having a browser operably connected to an email web server that provides an email web service, comprising:
a personal imaging repository for storing imaging data that is to be accessed by requested web services;
an email web content for emailing selected imaging data stored in said personal imaging repository responsive to user selection,
said email web content being generated by the email web server and available for transferring to the browser; and,
an email web server for providing said email web content and transferring the selected imaging data to a recipient mail server;
wherein said personal imaging repository is an exchange infrastructure between the imaging data and available web services on the Internet.

2. The system as defined in clalm 1 further comprising a browser provided by an imaging client computer for displaying information to the user as a function of said email web content.

3. The system as defined in claim 1 further comprising an extension component providing access to user information for associating said email web content to said personal imaging repository.

4. The system as defined in claim 3 wherein said user information is stored on the client computer.

5. The system as defined in claim 1 wherein said personal imaging repository comprises an imaging data store for storing the imaging data and a composition store for storing imaging compositions having links to the imaging data serviced as a single unit.

6. The system as defined in claim 5 wherein said imaging data store and said composition store are located on a single server connected to said imaging client.

7. The system as defined in claim 5 wherein said imaging data store and said composition store are located on separate servers connected to said imaging client.

8. The system as defined in claim 5 wherein said imaging data store and said composition store are located on said imaging client.

9. The system as defined in claim 1 wherein said email web content includes a page that displays a list of all imaging data available on said personal imaging repository for user selection.

10. A method for sending, via email, imaging data stored in a personal imaging repository, having an imaging data store for storing the imaging data and a composition store for storing imaging compositions having links to the imaging data serviced as a single unit, located on an imaging client computer operably connected to an email web server providing an email web service, said method comprising:
requesting web content from the email web service by the imaging client computer;
responding to the request by supplying email web content to the imaging client computer by the email web server;
displaying and executing the email web content by the imaging client computer;
accessing selected imaging data from the personal imaging repository by the email web content;
transferring selected imaging data along with user configuration to the email server by the email web content; and,
sending the imaging data and the user configuration with an email message to the recipient mail server.

11. The method according to claim 10, wherein prior to said step responding to the request further comprising the steps of:
determining whether the connection with the email web service is successful; and,
returning an error message to the user when the connection with the email web service is not successful.

12. The method according to claim 10, wherein prior to the step of accessing selected imaging data further comprising the steps of:
accessing each imaging composition stored in the composition store to obtain a list of links for all imaging data in the personal imaging repository;
retrieving the imaging data in a form that can be displayed on the browser;
displaying the retrieved imaging data on the browser; and,
selecting from the retrieved imaging data by the user.

13. The method according to claim 10 wherein prior to the step of accessing selected imaging data further comprising the step of selecting send from the email web content by the user.

14. The method according to claim 10 further comprising the steps of:
providing destination email address by the user;
selecting a send configuration for the selected imaging data by the user;
providing comments for the email message by the user; and,
selecting send from the email web content by the user.

15. The method according to claim 14 wherein said step of selecting send from the email web content further comprising the steps of:
requesting the selected imaging data in the desired user configuration from the imaging data store by the email web content; and,
responding with the selected imaging data in the desired user configuration by the composition store.

16. The method according to claim 10 wherein the step of transferring selected imaging data further comprising the steps of:
configuring the selected imaging data according to user selection by the email server; and,
composing the email message by the email server.

17. A computer program product comprising a computer usable medium having computer readable program codes embodied in the medium that when executed causes a computer to:
request web content from the email web service by the browser;
respond to the request by supplying email web content to the browser;
display and execute the email web content by the browser;
access selected imaging data from the personal imaging repository by the email web content;
transfer selected imaging data along with user configuration to the email server by the email web content; and,
send the imaging data and the user configuration with an email message to the recipient mail server.
